(19) United States
(12) Patent Application Publication
(10) Pub. No.: US 2010/0181929 A1
(43) Pub. Date: Jul. 22, 2010

(54) SERIAL TYPED IC'S TRANSMISSION METHOD OF CODING SEQUENCE

(76) Inventor: Peter Liao, Jhubei (TW)

Correspondence Address: LEONG C LEI, PMB # 1008, 1867 YGNACIO VALLEY ROAD, WALNUT CREEK, CA, 94598, US

(21) Appl. No.: 12/356,094

(22) Filed: Jan. 20, 2009

(51) Int. Cl. H05B 37/04

(52) U.S. Cl. 315/297

(57) ABSTRACT

The present invention is to provide a coding sequence's transmission method for the serial typed IC used in a decoration lamp, which mainly applies a dynamic coding technology to a design requiring to initially setup the coding sequence in each time such that each IC adopts the serial typed sequencing transmission and becomes a form with an effect of varying IC address dynamically. While one of the ICs is damaged, it only needs to take a new IC then exchange it directly, and that is all. It can solve the problems of inconvenience in the past that the serial transmission ICs need to burn in the sequence numbers and positioning every IC's addresses, and it needs to get an IC with the same sequence number for exchanging while one of the ICs is damaged.

### PRIOR ART OF THE INVENTION

A serial typed ICs' transmission used in the known decoration lamp is a design requiring to initially setup the coding sequence in each time. As shown in FIG. 1, it is a diagram of the distribution form in a serial typed transmission IC of the prior art. It is a design form of varying IC address statically that ICs at every addresses need to burn-in different sequence numbers, for example, the IC at address 1 has the sequence number A then the IC at address must have the different sequence number B. The ICs at every address are respectively burned-in with different sequence numbers in sequence, and the ICs with different sequence numbers have no common usage. Therefore, it needs to prepare spare parts of ICs with different sequence numbers. And, it needs to get a new IC with the same sequence number for exchanging while one of the ICs in the series is damaged otherwise the serial typed ICs are unable to proceed the transmission. It thus causes the complexity and inconvenience in the maintenance work and really waits to be improved.

### SUMMARY OF THE INVENTION

The object of the invention is to adopt a serial typed sequencing transmission to replace the serial typed IC transmission varying IC address statically such that each IC in the series becomes a form of varying IC address dynamically. Through this, while one of the ICs in this series is damaged, it only needs to take a new IC then exchange it directly, and that is all. It can solve the problems of inconvenience in the past that the serial transmission ICs need to burn in the sequence numbers and positioning every IC's addresses, and it needs to get an IC with the same sequence number for exchanging while one of the ICs is damaged otherwise the serial typed ICs are unable to proceed the transmission thus cause the inconvenient maintenance.

### BRIEF DESCRIPTION OF THE DRAWINGS

FIG. 1 is a diagram of the distribution form in a serial typed transmission IC of the prior art.

FIG. 2 is a diagram of the distribution form in a serial typed sequencing transmission IC according to the present invention.

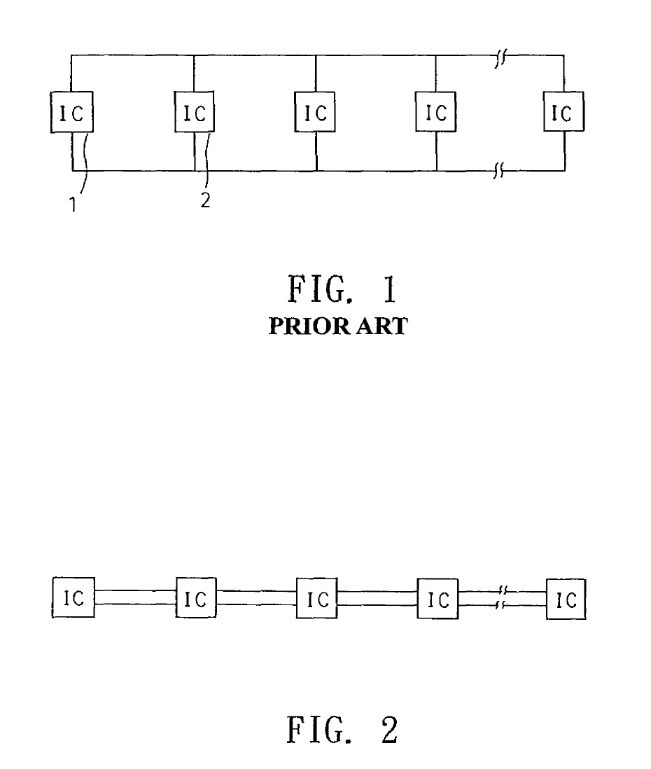

### DETAILED DESCRIPTION OF THE PREFERRED EMBODIMENT

Please refer to FIG. 2. The present invention is a coding sequence's transmission method for the serial typed IC used in a decoration lamp, which mainly applies a dynamic coding technology to a design requiring to initially setup the coding sequence in each time such that each IC adopts the serial typed sequencing transmission and becomes a form with an effect of varying IC address dynamically. The features of this serial typed sequencing transmission are in that there is no need to burn-in the sequence numbers for ICs in every address in advance, and the IC addresses in the series are coded automatically while initially being operated in each time. Its advantages are in that it only needs to take a new IC then exchange it directly while one of the ICs in this series is damaged. The IC addresses in the series are coded again automatically while the serial transmission is initially operated once again such that the serial typed sequencing ICs can continuously proceed the transmission function.

I claim:

1. A coding sequence's transmission method for a serial typed IC used in a decoration lamp mainly applying a dynamic coding technology to a design requiring to initially setup the coding sequence such that each IC adopts the serial typed sequence transmission and becoming a form with an effect of varying IC address dynamically.
